(19) United States
(12) Patent Application Publication
(10) Pub. No.: US 2025/0191481 A1
(43) Pub. Date: Jun. 12, 2025

(54) GUIDANCE FUNCTION(S) FOR USE OF LARGE LANGUAGE MODELS WITHIN EDUCATIONAL ENVIRONMENTS

(71) Applicant: Microsoft Technology Licensing, LLC, Redmond, WA (US)

(72) Inventors: Emma Margaret GRAY, Vancouver (CA); Isobel Matilda MCCRUM, Brooklyn, NY (US); Alisa Marilyn BACON, Seattle, WA (US)

(21) Appl. No.: 18/537,086

(22) Filed: Dec. 12, 2023

(51) Int. Cl. G09B 5/02; G06F 40/279

(52) U.S. Cl. CPC G09B 5/02; G06F 40/279

(57) ABSTRACT

Systems and methods for providing a guidance function for use of large language models within educational environments are provided herein. In an example, a system includes instructions to receive, from a first client device, a request to generate content within an application and initiate, by the application, a guidance function. The guidance function observes interactions between the first client device and a content generator and determines a first interaction between the first client device and the content generator. The guidance function also determines a first text portion generated based on the first interaction between the first client device and the content generator and generates a relationship between the first text portion and the first interaction between the first client device and the content generator. The guidance function may also store the relationship between the first text portion and the first interaction.

### TECHNICAL FIELD

Aspects of the disclosure are related to the field of computer software applications and services and, in particular, to large language models and their use within educational environments.

### BACKGROUND

Recent advances in computing and communication technologies have resulted in the introduction of powerful content generators, such as large language models (LLMs), into the everyday stream of online experiences. LLMs have been integrated into numerous environments such as search, content creation, and gaming. Users interact with LLMs in a conversational manner by submitting prompts that elicit responses from an LLM. In an academic scenario, a student may receive an assignment, for example, to draft an essay on what astronauts eat when in space. The student may engage with an LLM-powered chat bot as a starting point on what astronauts eat. For instance, the student may engage with an LLM-powered chat bot to obtain a summary of the top concerns astronauts have when developing a menu for a space mission. The student may then use the responses generated by the LLM-powered chat bot to draft the essay for the assignment.

Over recent years, however, the use of LLMs within academic and educational settings has raised concerns over the risk of plagiarism. For example, educators are often concerned about the authorship of papers submitted by students as it can be difficult to discern what content of the papers is generated by the student and what content is generated by LLMs. That is, when a student submits an assignment, an educator may not be able to tell what content of the assignment the student's own words and what content is generated by an LLM.

To address plagiarism concerns, some educators institute a ban on LLM use during assignments. A moratorium on LLMs, however, may disadvantage students. The use of content generators, including LLMs, is becoming commonplace within the everyday workforce. As such, prohibiting students from learning to use LLMs prior to entering the workforce can prevent students from learning valuable skills. As such, there is a need for a guidance function that allows educators transparency to supervise students as they learn and interact with LLMs.

### SUMMARY

Technology disclosed herein includes software applications and services that provide guidance functionality for use of large language model (LLM) service(s) within educational scenarios. In particular, the guidance function can be initiated within an application, such as a collaboration or productivity application, and allows transparency to an educator on students' interactions with an LLM service. As a student generates content within the application (e.g., composes an essay), the guidance function observes interactions between the student and an LLM service. For example, if the student submits a prompt to the LLM service requesting information on a topic, the guidance function gathers information on the prompt submitted and a response provided by the LLM service responsive to the prompt. The guidance function then determines whether the student generates any content within the application based on that interaction with the LLM service. For example, if the student copies and pastes the response generated by the LLM service, the guidance function may highlight that text within the application. Optionally, the guidance function can provide a recommendation to the student to rewrite or rephrase the text in the student's own words.

The guidance function can also gather LLM interaction information for a grouping of users (e.g., students in the same class) and provide such information to a reviewing user. In other words, the guidance function determines how many interactions each student has with the LLM service during a given assignment or task and can provide statistical information on these interactions to the educator. This can allow the educator to understand how the class as whole is interacting with the LLM service and the assignment.

As described in greater detail below, the guidance function provided herein provides transparency between a reviewing user (e.g., educator) and reviewed users (e.g., students). The transparency provided by the guidance function strikes a balance between educator's concerns over authorship within educational scenarios and a student's desire and need to develop skills surrounding LLM services.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates an operational environment for providing guidance functionality for use of LLMs, according to an embodiment herein;

FIG. 2 illustrates a brief operational scenario to further highlight an application of the guidance functionality, according to an embodiment provided herein;

FIG. 3 illustrates a graphical user interface (GUI) for providing guidance functionality, according to an embodiment herein;

FIG. 4 illustrates a GUI providing a visual indication of a relationship between generated content and an LLM interaction, according to an embodiment herein;

FIG. 5 illustrates another GUI providing a visual indication of a relationship between generated content and an LLM interaction, according to an embodiment herein;

FIG. 6 illustrates a GUI including an interaction history summary for a group of reviewed users, according to an embodiment herein;

FIG. 7 illustrates a GUI providing an interaction history view, according to an embodiment herein;

FIG. 8 illustrates a process for providing guidance functionality, according to an embodiment herein; and

FIG. 9 shows an example client device suitable for providing guidance functionality, according to an embodiment herein.

### DETAILED DESCRIPTION

Examples are described herein in the context of systems and methods for providing guidance functionality for use of content generators, such as LLMs. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

As noted above, content generators, such as LLMs, are increasingly becoming a fixture of everyday life. As such, it can be valuable for individuals, such as students, to learn how to safely and effectively interact with LLMs. Although the following description follows the example of an educator-student scenario, it should be appreciated that the systems and methods described herein may be applied to other scenarios in which there is an observer/reviewer (e.g., educator, manager, director) and a reviewed/observed user (e.g., student, employee, worker). In fact, the systems and methods described herein may be applied to scenarios in which the observer and observed user are the same individual. For example, an individual may want to track his or her progress and as such may fulfill both roles. Additionally, for ease of discussion, the content generator is described as an LLM but it should be appreciated that other content generators are contemplated herein, including multimodal generative models. For example, the systems and methods provided herein may be equally applicable for use with text-to-image generators, such as Stable Diffusion™ or DALL-E, and image-to-image generators.

A common concern with LLM use, including within the educational environment, is plagiarism. As described above, educators have become increasingly skeptical about authorship of assignments due to the use of LLMs. While complete bans of LLMs may address some of the plagiarism concerns, these bans not only fail to teach students how to safely and effectively interact with LLMs, but are often not effective. While most students may adhere to the ban of LLMs, a subset of students may continue to use LLMs for assignment preparation.

To provide insights on the use of LLMs within a given assignment, guidance functionality for LLM use is provided herein. The guidance function described herein provides transparency for those in a reviewing or observing role. Thus, the guidance function provides a balance between allowing educators see what content within an assignment is generated by a LLM and providing students with a supervised environment in which they can interact with LLMs, thereby providing a safe space for students to hone skills surrounding use of LLMs.

In addition to quelling authorship concerns, the guidance functionality provided herein also provides educators valuable insights on how students approach an assignment. As will be described in greater detail below, the guidance function provides educators with the prompts submitted to an LLM by a student and the responses generated therefrom. By providing educators with the prompts submitted to the LLM, the educator can see how students interpret and understand the assignment. From the student's perspective, this transparency also provides students with a platform to demonstrate learning and understanding of the assignment beyond the finished product. That is, the educator can see a student's progression and understanding of an assignment via the prompts submitted to the LLM.

Overall, the guidance function provided herein not only improves the educational environment by providing transparency to educators for content authorship, but it also provides students the ability to hone their knowledge and skills surrounding use of LLMs. The more students are able to practice LLM use, the more efficient they will become with their interactions with LLMs. An increase in efficiency, individually and in the aggregate, can reduce human-computer conversational churn, which in turn reduces the computing resources required of the LLM engines that process the prompts. A reduction in conversational churn may reduce demand on a global scale for the energy required to power modern LLM engines. At a more local level, reduced conversational churn consumes less battery power (e.g., on mobile devices) since fewer queries are needed, to say nothing of improving the basic user experience with respect to LLMs. Improved prompting also reduces the time it takes a user to find and access relevant information, time which may be spent on other productive activities.

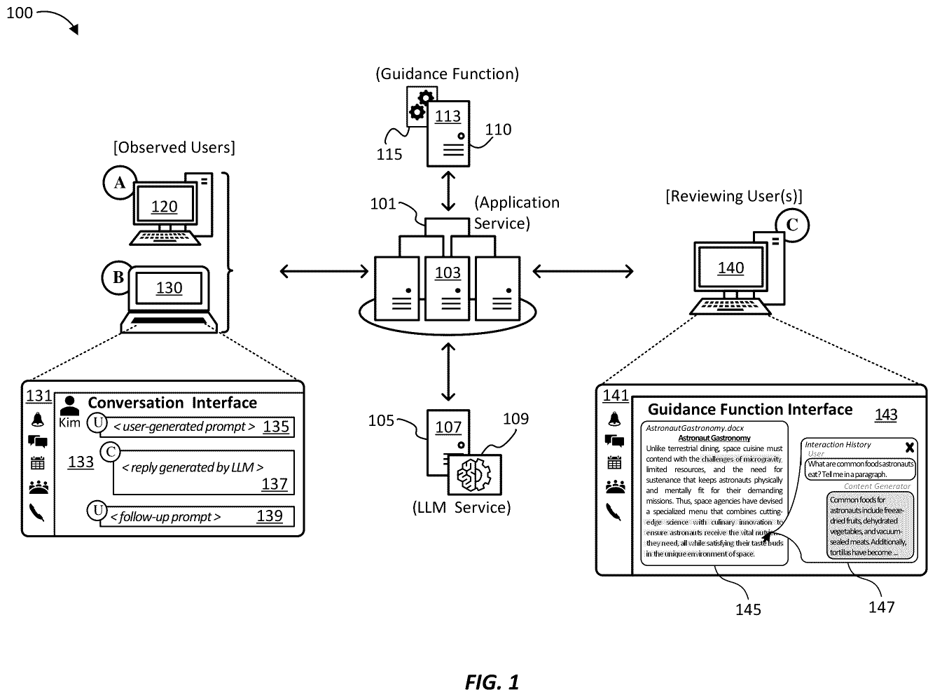

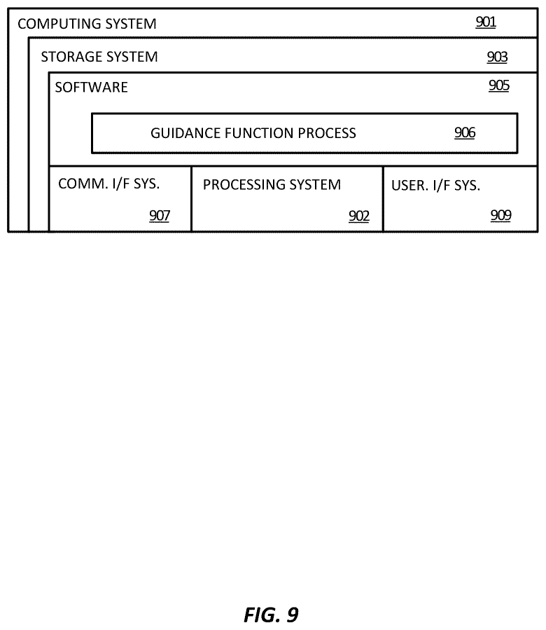

Turning now to FIG. 1, FIG. 1 illustrates an operational environment 100 for providing guidance functionality for use of LLMs, according to an embodiment herein. As illustrated, the operational environment 100 includes an application service 101, an LLM service 105, and a guidance function 110, as well as client devices 120, 130 and 140. The application service 101 employs one or more server computers 103 co-located with respect to each other or distributed across one or more data centers. Example servers include web servers, application servers, virtual or physical servers, or any combination or variation thereof, of which computing system 901 in FIG. 9 is broadly representative.

The client devices 120, 130, and 140 communicate with application service 101 via one or more internets and intranets, the Internet, wired and wireless networks, local area networks (LANs), wide area networks (WANs), or any other type of network or combination thereof. Examples of the client devices 120, 130, and 140 may include personal computers, tablet computers, mobile phones, gaming consoles, wearable devices, Internet of Things (IoT) devices, and any other suitable devices, of which computing system 901 in FIG. 9 is also broadly representative.

Broadly speaking, the application service 101 provides software application services to end points, such as the client devices 120, 130, and 140, examples of which include productivity software for creating content (e.g., word processing, spreadsheets, and presentations), email software, and collaboration software. The client devices 120, 130, and 140 load and execute software applications locally that interface with services and resources provided by the application service 101. The applications may be natively installed and executed applications, web-based applications that execute in the context of a local browser application, mobile applications, streaming applications, or any other suitable type of application. Example services and resources provided by the application service 101 include front-end servers, application servers, content storage services, authorization and authentication services, and the like.

The application service 101 includes an integration with the LLM service 105 to support conversational interactions between users and LLM-powered chat bots and other types of artificial intelligence (AI) tools. The LLM service 105 employs one or more server computers 107 co-located with respect to each other or distributed across one or more data centers, of which computing system 901 in FIG. 9 is broadly representative. The LLM service 105 hosts LLM engine 109 on server computers 107. The LLM engine 109 is representative of an LLM-powered AI model capable of interacting in a conversational manner via prompts generated by users of other applications and services, and responses generated by the LLM engine in response to the prompts.

The application service 101 also includes an integration with the guidance function 110, which is capable of analyzing and reporting on the conversational interactions between users and the LLM engine 109. The guidance function 110 employs one or more server computers 113 co-located with respect to each other or distributed across one or more data centers, of which computing system 901 in FIG. 9 is broadly representative. The guidance function 110 hosts guidance engine 115 on server computers 113. The guidance engine 115 is representative of analytics software capable of capturing the prompts and responses exchanged between user applications and the LLM service 105, analyzing the interactions between the user and the LLM service 105, analyzing content generated by the user via the application service 101, and providing a visual indication of a relationship between the content generated in the application service 101 and the interaction with the LLM service 105.

The application service 101 and the guidance function 110 observe the interactions between users of the client devices 120 and 130 and the LLM service 105. Here, user A constructs prompts in the context of software applications running on the client device 120 and user B constructs prompts in the context of software applications running on the client device 130. The prompts may be submitted via the application service 101 to the LLM service 105 and the guidance function 110. Responses generated by the LLM service 105 responsive to the prompts may be received by the guidance function 110 when the application service 101 provides those responses to the client devices 120 and 130. In an educational context, users A and B may be students.

The guidance function 110 may observe the interactions of users A and B with the LLM service 105 and provide information relating to those interactions to a reviewing user. As illustrated, the reviewing user may be user C who receives the interaction information in the context of software applications running on the client device 140. In an educational context, user C may be an educator or professor.

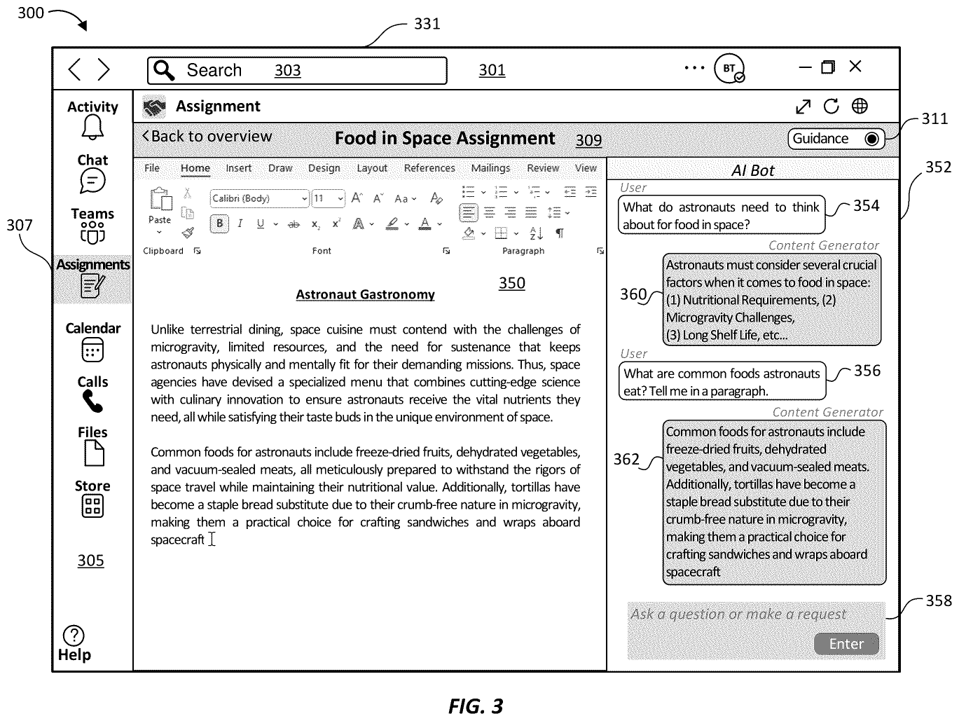

As noted above, a technical improvement of operational environments provided herein, specifically those including the guidance function 110, is they allow observed users, such as users A and B, to safely and effectively interact with LLM services, such as the LLM service 105, while also providing users in a supervisory position, such as user C, transparency as to the interactions between the observed users and the LLM services. As will be described in greater detail below with respect to FIGS. 3-7, the transparency provided to reviewing users can include the prompts and responses in a given LLM service interaction and an identification of content generated by the observed user within an application, corresponding to a given interaction with the LLM. As will be appreciated by those skilled in the art, this type of transparency is not available in conventional applications and related products.

In operation, users A and B may engage with the LLM service 105 in a variety of ways, including through conversational components of local applications running on the client devices 120 and 130, respectively. Interactions by a given user with the LLM service 105 are observed and analyzed by the guidance function 110. The guidance function 110 then observes content generated by the user within a respective document hosted by the application service 101 based on those interactions. Upon analyzing the interaction and the generated content, the guidance function 110 determines a relationship between a given interaction and content generated by the user. The guidance function 110 then generates a visual indication of the relationship and provides the visual indication to the reviewing user, here user C. User C may evaluate the visual indication and the interactions by users A and B with the LLM service 105 via an application or tool running on client device 140.

To submit a prompt to the LLM service 105, user A and/or B supplies natural language input in the form of typed text, spoken (audible) words, or other suitable input methods that form the basis of a prompt to the LLM service 105. The LLM service 105 receives the prompt, processes it, and returns a response that (presumably) addresses a request, task, or other such statement included in the prompt. The success of the prompt depends at least partly on the prompting proficiency of the user. That is, the relative skill of the user with respect to prompting will play a role in whether the user's prompts elicit responses that are helpful, informative, and generally useful. This is one reason why it is important for students to develop skills around LLM services.

Following the illustrated example of FIG. 1, user B engages with the LLM service 105 via a user interface 131 to an application executing on the client device 130. The user interface 131 includes a conversational interface 133 through which user B may construct and submit prompts to the LLM service 105, as well as consume and interact with responses from the LLM service 105. The conversational interface 133 includes input components 135 and 139 for receiving natural language input from the user for generating the prompts. The conversational interface 133 also includes an output component 137, which is representative of components through which the application surfaces the responses from the LLM service 105. While illustrated as a text-based interface, it may be appreciated that one or both of the inputs and outputs could be provided in accordance with a different modality such as speech, audio, or other modes of input and output.

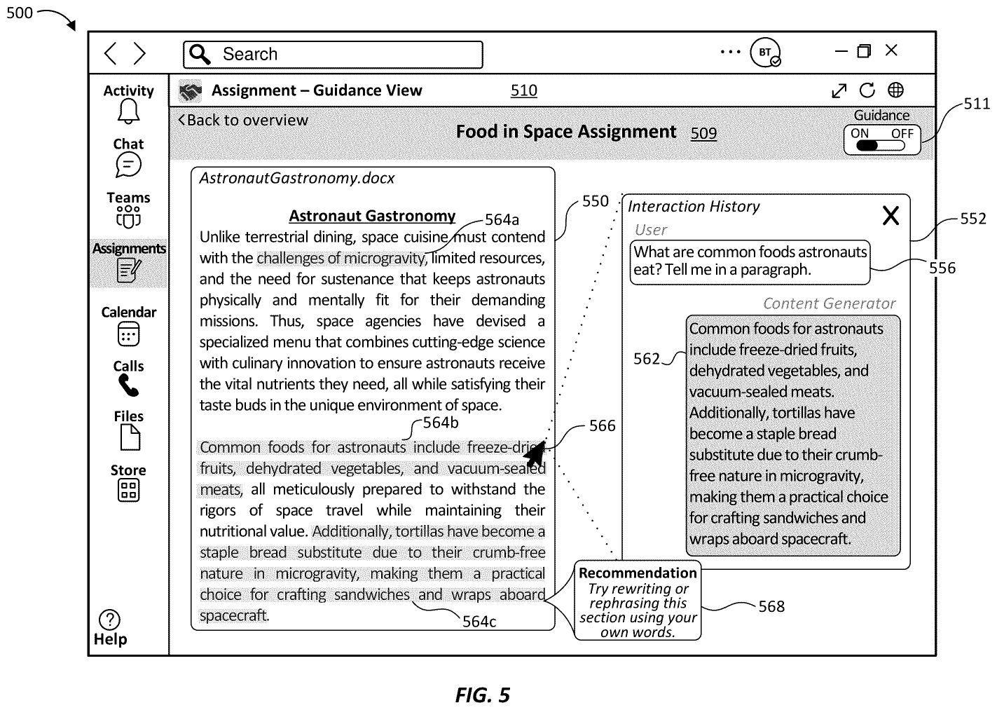

User C engages with guidance function 110 via a user interface 141 to an application executing on the client device 140. The user interface 141 includes a guidance interface 143 through which user C may obtain and consume interaction information with respect to the prompting by user A and user B. The guidance interface 143 includes components 145 and 147 that are representative of graphical user interface elements through which interaction information may be displayed. For example, the component 145 illustrates an assignment submitted by user B, via the application service 101, and includes content generated by user B. A portion of the content may be highlighted to indicate a relationship to an interaction between the user B and the LLM service 105. If user C selects a highlighted portion of text, the component 147 may be provided. The component 147 may provide the prompt and response exchanged between user B and the LLM service 105 during the related interaction. This example is illustrated and described in greater detail below with respect to FIG. 5.

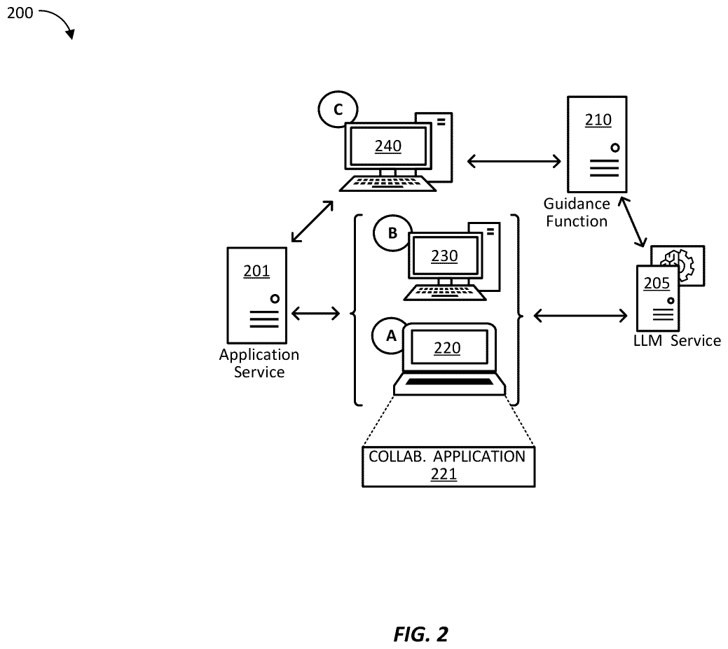

Turning now to FIG. 2, FIG. 2 illustrates a brief operational scenario 200 to further highlight an application of the guidance functionality, according to an embodiment provided herein. As shown, in operational scenario 200, there are two observed users (e.g., students), users A and B, and a reviewing user (e.g., educator), user C. Users A and B may operate the client devices 220 and 230, respectively. The client devices 220 and 230 may be the same or similar to the client devices 120 and 130 described above with respect to FIG. 1. Similarly, user C may operate the client device 240, which may be the same or similar to the client device 140.

Following an example for user A, user A may open an application, such as a collaboration application 221 (e.g., word processor), to begin generating content. To open the application, the client device 220 may communicate with an application service 201, which may be the same or similar to the application service 101. The application service 201 may initiate and operate the collaboration application 221 on the client device 220. Once the application is open on the client device 220, user A may begin to generate content within the collaboration application 221 by, for example, typing text into the collaboration application 221.

In some embodiments, upon initiating the collaboration application 221 on the client device 220, software corresponding to the guidance function 210 may also be initiated. That is, settings associated with the collaboration application 221 may indicate that any content generated within the collaboration application 221 should be observed by the guidance function 210. For example, if user C is an educator, user C may have assigned an essay to be drafted in the collaboration application 221. As part of the assignment, user C may have selected a setting to have the guidance function 210 observe drafting of the essay. As such, when user A, here a student, opens and begins drafting the essay, the guidance function 210 automatically begins observing.

As user A begins generating content within the collaboration application 221, user A may submit a prompt to a content generator, such as an LLM service 205. The LLM service 205 may be the same or similar to the LLM service 105. User A submits the prompt to the application service 201 which routes the prompt to the LLM service 105. The application service 201 also sends a copy of the prompt to the guidance function 210. In some cases, instead of sending the copy of the prompt to the guidance function 210, the application service 201 or the LLM service 205 creates a record of the prompt interaction that the guidance function 210 references to provide insights. In some scenarios, the collaboration application 221 on client device 130 may send the prompt to one or both of the LLM service 205 and the guidance function 210 directly, rather than via the application service 201.

Upon receiving the prompt, the LLM service 105 generates a response and returns the response to the client device 230, either through the application service 201 or directly to the client device 230. The client device 130 displays the response for user A's consideration, resulting in user interactions such as user A formulating a follow-up prompt, clicking on a link in the response, or the like. User A's interactions are logged by the guidance function 210, or a related application executed on the client device 230 and communicated to the guidance function 210 therefrom.

The guidance function 210 also receives content generated within the collaboration application 221 by user A. That is, as user A types content into the collaboration application 221, the collaboration application 221 may submit the content to the guidance function 210, either directly or via the application service 201. The guidance function 210 then processes the content generated in the collaboration application 221 and the interaction (e.g., prompt and response) with the LLM service 205. If the guidance function 210 determines a relationship between the interaction and the content generated in the collaboration application 221, the guidance function 210 may generate a visual indication of the relationship. The relationship determined by the guidance function 210 and visual indications generated based on a relationship are described in greater detail below with respect to FIGS. 3-5.

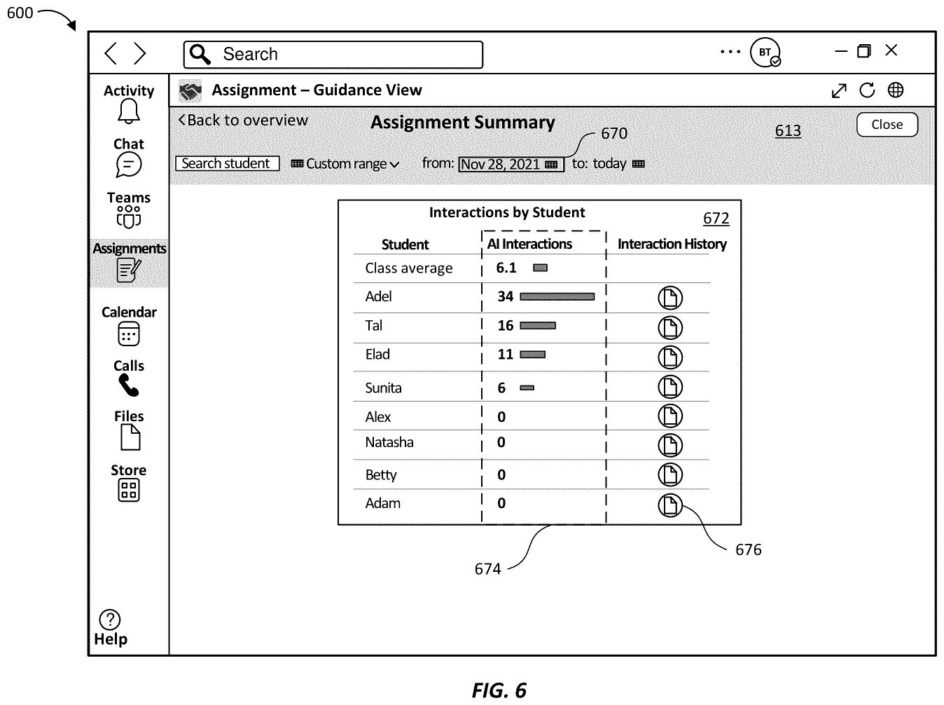

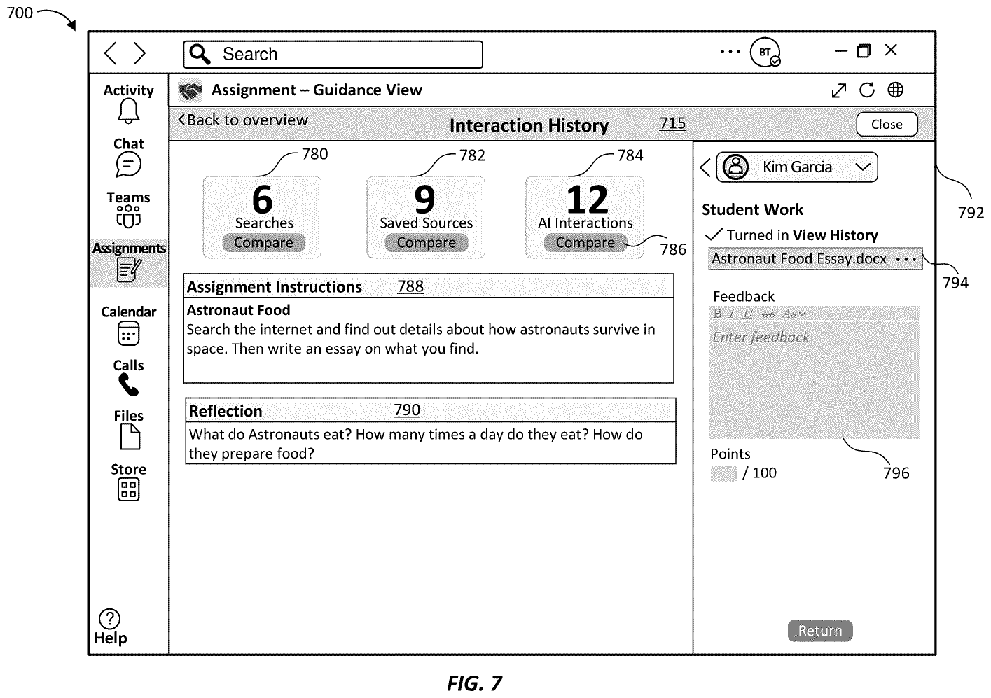

As user A generates and completes a task in the collaboration application 221, the guidance function 210 observes, gathers, and tracks interactions between the client device 230 and the LLM service 205. Simultaneously, the guidance function 210 also observes content as it is generated within the collaboration application 221 and determines a relationship between the content and an interaction with the LLM service 205. Once the task is complete, the guidance function 210 supplies an insight on the interaction to the client device 240, such as via the guidance interface 143, to user C. The guidance function 210 may supply the insight on the interaction to the client device 240 upon request, automatically, or at some other interval. For example, user C may navigate to a page that references user A, thereby triggering a request by user C's application to guidance function 210 for the interaction information about user A. The guidance function 210 responsively generates the insight or interaction information, and delivers them to the application on client device 240 for display to user C. Such applications and displays are described in greater detail below with respect to FIGS. 6 and 7.

Turning now to FIGS. 3-7, various user interfaces are provided in an education-based scenario to demonstrate various facets of the guidance functionality disclosed herein, although it may be appreciated that the concepts apply as well to other settings, situations, and scenarios.

Beginning with FIG. 3, FIG. 3 illustrates a GUI 300 for providing guidance functionality, according to an embodiment herein. Specifically, the GUI 300 illustrates a user interface 331 that an observed user, such as a student, may interact with. For example, the GUI 300 may illustrate an example user interface 131, as referenced in FIG. 1, provided to user B via the client device 130.

The user interface 331 includes components associated with a collaboration application (e.g., the collaboration application 221 in FIG. 2), including components 301, 303, 305, 307, and 309. The component 301 is representative of a main title bar that allows a reviewing user to, among other functions, open, close, minimize, or maximize user interface 331. The component 301 includes a search box 303 via which a user may input search queries with respect to content in the collaboration application such as documents, contacts, and other material.

The component 305 is representative of a feature bar that includes various icons for accessing modules of the application. For instance, the component 305 includes an activity icon for checking alerts or reminders, a chat icon for chatting with other users, an icon for accessing team-oriented flows, an assignments icon for posting and reviewing assignments, a calendar icon for accessing a calendar feature, a call icon for placing voice calls, a files icon for managing files, and a store icon for accessing an app store. In some implementations, the component 305 may include an icon for accessing a guidance module, a guidance function add-in application, or the like.

The app store—accessible via the store icon—provides the user with the ability to download and install “add-in” applications that are integrated into the context of the main application. Here, it is assumed for exemplary purposes that the user has installed a guidance application through the store (or by another mechanism) or that the guidance application was otherwise installed. As illustrated in FIG. 3, the guidance application can be loaded and executed in the context of another application, such as the collaboration application 221 described with respect to FIG. 2. Thus, the user interface 331 also includes various components associated with the guidance application, such as panel 352. As mentioned, the guidance application may be launched from an icon in the component 305. Alternatively, the guidance application may be provided as a feature of existing functionality of the collaboration application. For example, the guidance application may automatically initiate and execute when the user opens the collaboration application. As will be described in greater detail below, a reviewing user, such as an educator, may select a guidance setting when creating an assignment such that the guidance application automatically executes when a student begins an assignment.

Following the above educational scenario, a student navigates to an assignment via an assignment icon 307. Upon selection of the assignment icon 307, the user may be presented with an overview of tasks assigned to the user (not shown). One such task, may be a “Food in Space Assignment” in which the student is tasked with writing an essay on what astronauts eat in space. As illustrated, when the user opens this assignment, an assignment view 309 is provided. The assignment view may include a panel 350 corresponding to a collaboration application, such as the collaboration application 221, and the panel 352, corresponding to a LLM service, such as the LLM service 105.

As noted above, an LLM service may be provided within the context of a collaboration application as an add-in or plug-in. FIG. 3 may illustrate such an example. That is, the panel 352 may provide LLM functionality within or in association with the panel 350 of the collaboration application 221. As a student begins drafting the essay within the panel 350, the student may submit prompts 354 and 356 to the LLM service 105 via the panel 352. In particular, the student may submit a prompt via the input field 358. As noted above, when the student submits a prompt via the input field 358, the prompt may be transmitted to the LLM service 105, either directly or via the application services 101.

Responsive to the prompts 354 and 356, the LLM service 105 generates responses 360 and 362, respectively. That is, the LLM service 105 generates the response 360 responsive to the prompt 354 and the response 362 responsive to the prompt 356. The panel 352 may provide a record or history of the interactions between the LLM service 105 and the student. In other words, an interaction, as used herein, may include a prompt submitted by the student and the response generated by the LLM service 105.

In some embodiments, when a reviewing user (e.g., educator) generates the assignment or task, the reviewing user may select an option for a guidance function. As such, when the student prepares the assignment, the guidance function, such as the guidance function 110, may be initiated to observe the student's interactions with the LLM service 105. To indicate that the guidance function is observing preparation of this assignment, a guidance indicator 311 may be provided within the assignment view 309. In this manner, there is full transparency between the student and the educator during preparation of the assignment.

As can be appreciated, as the student drafts the assignment, information from the responses 360 and 362 may be incorporated into the content of the assignment. While incorporation of information from the responses 360 and 362 into the content of an assignment is understood as allowable under general classroom expectations, direct copying or verbatim drafting of content based on the responses 360 and 362 is not.

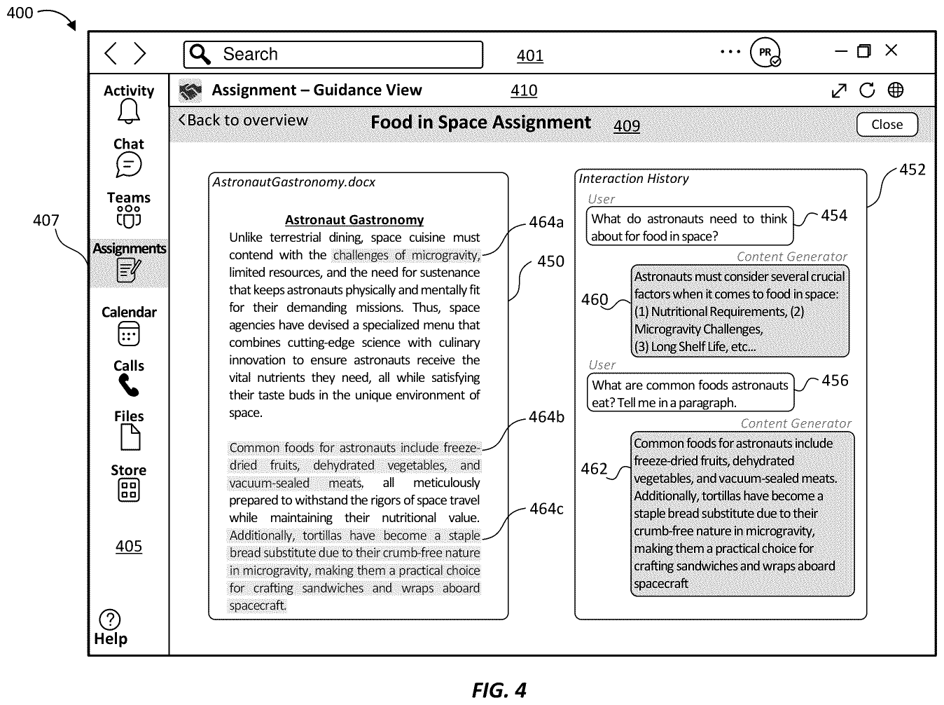

Referring now to FIG. 4, FIG. 4 illustrates a GUI 400 providing a visual indication of a relationship between generated content and an LLM interaction, according to an embodiment herein. For ease of discussion, FIG. 4 follows the above example of a student preparing an assignment on what astronauts eat in space. As such, the GUI 400 may include components 401, 405, 407, and 409, which may be similar to components 301, 305, 307, and 309. The GUI 400 provides a guidance view 410 of the assignment as prepared by a student. The guidance view 410 may be provided to a student via a user interface, such as the user interface 131, or may be provided to an educator via a user interface, such as the user interface 141.

The guidance view 410 includes panel 450 and panel 452. The panel 450 may correspond to a view of content generated within the panel 350. That is, the student may finish drafting the essay within the panel 350 and view the finished essay within the panel 450, or during drafting, the student may view the essay, in an unfinished state, to see what content within the essay corresponds directly to responses generated by the LLM service 105. In another scenario, a student may submit the essay via a corresponding platform to the educator, who may view the submitted assignment via the guidance view 410, including the panels 450 and 452. It should be appreciated that the panel 340 and the panel 450 may be the same panel, simply illustrated at different snapshots of time. As such, any of the features of FIG. 4, and the following Figures, may be used in combination with the features of any preceding (e.g., FIG. 3) or proceeding Figure.

Similarly, the panel 452 corresponds to the panel 352 in that it provides a record of the exchanges between the student and the LLM service 105. For example, the panel 452 includes prompts 454 and 456 submitted by the student to the LLM service 105, which correspond to the prompts 354 and 356. The panel 452 also includes the responses 460 and 462 that were generated by the LLM service 105 responsive to receiving the prompts 454 and 456, respectively.

As noted above, when the guidance function 110 is on for a given assignment, the guidance function 110 observes the interactions between a student and the LLM service 105. An interaction may include a prompt and response exchange submitted via the panel 352. Once an interaction is identified, the guidance function 110 then determines whether content generated by the student is based on that interaction. For example, the student may generate text based on the response 460 generated by the LLM service 105. In some cases, the student may generate a few words, a sentence, a whole paragraph, or a full document based on a single interaction with the LLM service 105. Methods of determining whether content generated by the student correspond to an interaction with the LLM service are further described herein.

If the guidance function 110 determines that generated content corresponds to an interaction with the LLM service 105, then the guidance function 110 generates a visual indication of a relationship between the generated content and the interaction. For example, the guidance function 110 may highlight text within the panel 450 to indicate that it relates to an interaction with the LLM service 105. As shown in FIG. 4, the guidance function 110 generates highlight 464a, highlight 464b, and highlight 464c to visually indicate that these portions of text correspond to interactions with the LLM service 105. For example, the highlight 464a relates to the response 460, and the highlights 464b and 464c relate to the response 462. This can allow a reviewing user (e.g., educator) the ability to view how the content was generated, including the student's thought process as drafting occurred, which may be appreciated by the progression of prompts 454 and 456. As should be appreciated, the highlights 464a, 464b, and 464c may be any form that emphasizes the respective text. For example, the highlights 464a, 464b, and 464c may be highlighted text, underlined text, alternative text color, font, size, and the like.

As noted above, the guidance view 410 may be provided to an observed user (e.g., student) to see what content within the document corresponds to an interaction with the LLM service 105. This can help students appreciate and curb directly copying language provided by the LLM service 105. In other words, the student can see that the portion of text covered by the highlight 464c is a verbatim copy of the response 462. Viewing this can provide the student the opportunity to rephrase or rework the portion of text into their own words.

In some embodiments, the guidance function 110 may generate recommendations to the student during drafting when content too closely matches responses generated by the LLM service 105. Referring now to FIG. 5, FIG. 5 illustrates GUI 500 for providing a visual indication of a relationship between observed user-generated content and an LLM interaction, according to an embodiment herein. Following the above example, the GUI 500 includes an assignment view 509. The assignment view 509 may be the same or similar to the assignment view 309 or 409. The assignment view 509 is provided within a guidance view 510, which may be the same or similar to the guidance view 410. The guidance view 510 may be provided to a student via a user interface, such as the user interface 131, or may be provided to an educator via a user interface, such as the user interface 141.

In the illustrated example, the assignment view 509 includes a guidance selection 511. If the assignment view 509 is provided to a student during completion of an assignment, then the guidance selection 511 may indicate the status of the guidance functionality 110 with respect to that given assignment. If the assignment view 509 is provided to an educator after submission of an assignment by a student, then the guidance selection 511 also indicates the status of the guidance function 110. Alternatively or additionally, the guidance selection 511 may also allow the educator to tab between engaging the guidance function 110 and disengaging the guidance function 110 during review of the assignment. That is, if the guidance function 110 is engaged, then the guidance view 510 is provided to the educator. If the guidance function 110 is disengaged during review of the assignment (e.g., the guidance selection 511 is tabbed to the “OFF” position), then the assignment may be viewable to the educator without any representation of interactions between the student and the LLM service 105.

When the guidance selection 511 is engaged, meaning that the guidance function 110 is initiated for an assignment, the guidance function 110 provides visual indication(s) of a relationship between content generated by an observed user within an application and interactions with the LLM service 105, as discussed above. As shown, a visual indication can include providing a display of the prompts and responses exchanged between a student and the LLM service 105. Another visual indication can include highlighting portions of text that correspond to an interaction with the LLM service 105. As described above with respect to FIG. 4, the guidance function 110 determines that a portion of text corresponds to an interaction with the LLM service 105 and can highlight the identified portion of text. Here, the guidance function 110 determines that highlights 564a, 564b, and 564c correspond to one or more interactions with the LLM service 105. The highlights 564a-c may be the same or similar to the highlights 464a-c.

In some embodiments, a user, such as the student or the educator, can select a highlighted portion of text with a cursor 566 to view a related interaction with the LLM service 105. Here, the cursor 566 selects the highlight 564b and upon selection, a panel 552 is provided. The panel 552, which may be the same or similar to the panels 352 or 452, includes a prompt 556 and a response 562. The prompt 556 may be the same or similar to the prompts 356 or 456, and the response 562 may be the same or similar to the responses 362 and 462, as described previously. Because the guidance function 110 determines that the interaction, including the prompt 556 and the response 562, relates to the portion of text highlighted by the highlight 564b, the guidance function 110 highlights that portion.

A relationship between content (e.g., text in a collaboration application) generated by an observed user and an interaction with the LLM service 105 may be determined by the guidance function 110. For example, the guidance function 110 may determine a relationship between a portion of text and an interaction based on the timing of the interaction and generation of the portion of text. That is, if the guidance function 110 determines that the portion of text was generated directly after the student submitted the prompt 556 and received the response 562, then the guidance function 110 may determine that the portion of text relates to the interaction.

In another example, the guidance function 110 may determine a relationship between a portion of text and an interaction based on similar words or content between the two. That is, the guidance function 110 may compare the portion of text highlighted by the highlight 564b to the response 562 and determine a similarity between the two. The similarity may be based on the number of words that are the same or similar to each other. Here, the portion of text highlighted by the highlight 564b is similar to the text of the response 562. As such, the guidance function 110 may determine a relationship between the portion of text and the response 562.

In addition to determining a relationship between a portion of text and an interaction, the guidance function 110 may also provide recommendations. For example, the guidance function 110 may provide a recommendation 568 to a student to rewrite or rephrase the portion of text highlighted by the highlight 564c, for example, because the portion of text is similar to the text of the response 562. In other words, if the guidance function 110 determines that the text generated by the student is too similar to that of a response from the LLM service 105, then the guidance function 110 may provide a recommendation to the student to revise the generated text. As can be appreciated, the recommendation 568 may be provided in a variety of formats and methods. For example, the recommendation 568 may include interactive features, such as “yes/no” or “accept/decline” options. In such cases, the responses may be viewed by the reviewing user.

In some embodiments, revisions and edits made to the text may be provided to the student. For example, a control view may be provided in which the original text copied from response is pasted into the document and then edits made to the response are provided. This can allow the observed user the ability to see what modifications are made to the copied response.

In some embodiments, the guidance function 110 may determine authorship of a portion of text within an application. For example, as a student drafts the essay provided in prompt 550, the guidance function 110 may determine whether a portion of text is typed by the student or pasted into the application by the student. To determine authorship of a portion of text, the guidance function 110 determines the original format of the portion of text. The original format of the portion of text includes whether the text was pasted in or typed by the student via a respective client device. If the student pasted the text into the application, then the guidance function 110 may flag that portion of text as having unclear authorship. For example, if the student pasted in the portion of text highlighted by the highlight 564c, the guidance function 110 may flag that portion of text as possibly being generated by the LLM service 105. The guidance function 110 may also compare the pasted portion of text to the responses provided by the LLM service 105, such as the response 562. If the guidance function 110 determines that the pasted portion of text is the same or similar to the text of a response from the LLM service 105, the guidance function 110 may provide the recommendation 568 or may provide such an indication to the reviewing user (e.g., educator).

In some embodiments, the guidance function 110 assigns a revision score to a text portion during a determination of authorship of the text portion. A revision score may indicate the number of edits made to the text portion when the text portion was generated. If the text portion was pasted into the application, then the revision score would be low. For example, the revision score may be one or zero, indicating that no edits were made to the text portion. In contrast, if the text portion was generated by the student by the student typing the text into the application, then the revision score is likely to be higher. Generally, when text is generated within an application, there are numerous revisions performed by the drafter, such as deletions and additions to the text. As such, the higher a revision score for a portion of text, the more likely the guidance function 110 is to determine that the text was generated by the student. As can be appreciated, by observing the revisions made to a portion of text, the guidance function 110 can discourage students from typing in text verbatim from a LLM response.

Referring now to FIG. 6, a GUI 600 illustrating an interaction history summary 613 (assignment summary 613) for a group of reviewed users is provided, according to an embodiment herein. Following the above example, the summary 613 shown by GUI 600 is provided to the reviewing user (e.g., educator). The summary 613 provides a summary for each student within a group, such as each student in a class, on his or her interactions with the LLM service 105. The educator can filter, and view student summaries, for example, based on a time range by using the timeframe selection 670. Those skilled in the art can appreciate that the summaries for each student may be filtered by a variety of factors, such as assignment, class, time, etc.

The summary 613 includes a table 672 that provides a quick view of interaction statistics for each student. Specifically, the table 672 provides a number of interactions 674 for each student held with the LLM service 150. In some embodiments, the number of interactions 674 are visually illustrated as well, such as shown in FIG. 6. The number of interactions 674 may also provide a class average, so the reviewing user can appreciate how the class performed overall with a given assignment.

From the summary 613, the reviewing user (e.g., educator), can select option 676 to review an interaction history for a particular observed user on a given assignment. Although not illustrated, the summary 613 may include other options or components such as options linking to a document for a respective user.

Turning now to FIG. 7, FIG. 7 illustrates a GUI 700 providing an interaction history view 715, according to an embodiment herein. Following the above example, the reviewing user may select the option 676 for a student and be provided with the interaction history view 715. The interaction history view 715 provides statistics 780, 782, and 784 for a given student, here, Kim Garcia, on a respective assignment. The statistic 780 indicates the number of searches the student performed during preparation of the assignment, the statistic 782 indicates the number of sources that were saved, and the statistic 784 indicates the number of interactions the student had with the LLM service 105. As can be appreciated, other statistics may be gathered and provided via the interaction history view 715.

Each of the statistics 780-784 includes a compare button 786 that, upon selection, allows the reviewing user to view the statistic against other students' statistics or a student's past statistics. For example, the reviewing user, upon selection of the compare button 786, may be provided with the summary 613, as described above with respect to FIG. 6. The interaction history 715 also includes panels 788 and 790 that provide context for the assignment. For example, the panels 788 may provide the instructions that the students were given for the assignment or a recap or summary of the assignment. The panel 790 may provide a summary or recap of the prompts provided by the observed user. This may be useful to the reviewing user when evaluating the provided statistics, in particular the interaction statistic 784.

Upon reviewing the statistics, the reviewing user can select the corresponding assignment document 794 via panel 792. From the panel 792, the reviewing user can provide feedback via feedback field 796 and grade the assignment.

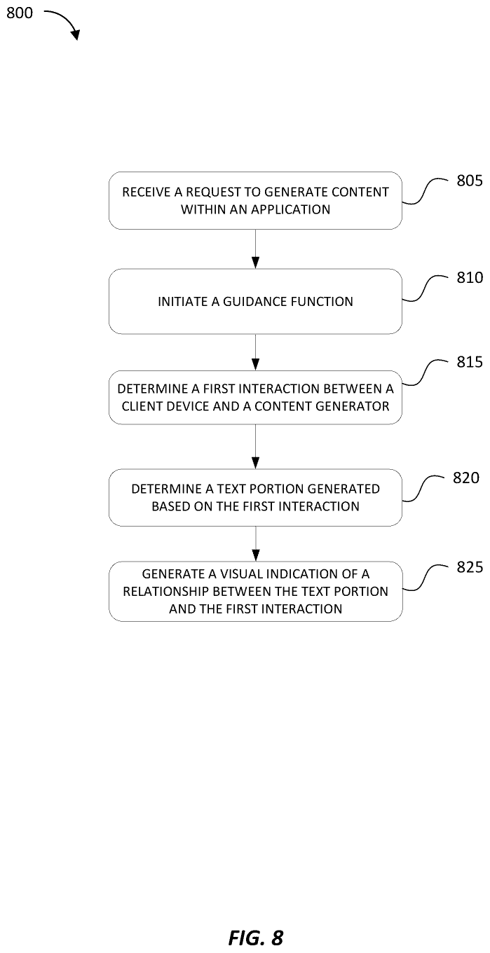

Referring to FIG. 8, FIG. 8 illustrates a process 800 employed by an application service, such as the application service 101, to observe interactions with an LLM service, such as the LLM service 105, according to an embodiment herein. Specifically, the process 800 illustrates a method for providing guidance functionality, as described herein. While the following description is provided with reference to systems and components of FIG. 1, it should be appreciated that the following description also relates to other systems and methods described herein, such as those provided in FIGS. 2-7. Additionally, the process 800 may be implemented in program instructions in the context of a software application, service, micro-service, or combination thereof running on one or more client devices. The program instructions direct the client devices to operate as follows, referring to a client device in the singular for the sake of simplicity.

As illustrated, the process 800 includes receiving a request to generate content within an application (805). For example, the application service 101 may receive a request from the client device 130 to open a collaboration application corresponding to an assignment. Responsive to the request, the application may initiate a guidance function, such as the guidance function 110 (810). As described above, the guidance function 110 may be initiated as part of the collaboration application. In some embodiments, the application may first determine one or more settings associated with the assignment and then initiate the guidance function 110 based on the settings associated with the assignment.

Once the guidance function 110 is initiated or engaged for a given assignment, the guidance function 110 determines an interaction between the client device 130 and a content generator, such as the LLM service 105 (815). For example, the guidance function 110 determines that the client device 130 transmits a prompt to the LLM service 105 and receives a response therefrom responsive to the prompt.

After an interaction is determined, the guidance function 110 determines a text portion that is generated based on the interaction between the client device 130 and the LLM service 105 (820). Then, the guidance function 110 generates a visual indication of a relationship between the text portion and the first interaction (825). As described above, the guidance function 110 may provide a display of the prompt and the response corresponding to the interaction between the client device 130 and the LLM service 105. The panel 452 or 552 are illustrative examples of such a display. The guidance function 110 can also highlight the text portion that is related to an interaction.

In some embodiments, the process 800 or a corresponding process may also include receiving a request for an interaction history for client devices associated with an assignment or group of reviewed users (e.g., students). For example, the guidance function 110 may generate the summary 613 of interaction histories for a group of users, or the guidance function 110 may generate an interaction history 715 for an individual user.

Referring to FIG. 9, FIG. 9 illustrates a computing system 901 that may be used for providing guidance functionality, as described herein. For example, the client device 120 or 130 may be or include the computing system 901. As illustrated, the computing system 901 includes a processing system 902 that includes a microprocessor and other circuitry that retrieves and executes software 905 from storage system 903. The processing system 902 may be implemented within a single processing device but may also be distributed across multiple processing devices or sub-systems that cooperate in executing program instructions. Examples of the processing system 902 include general purpose central processing units, graphical processing units, application specific processors, and logic devices, as well as any other type of processing device, combinations, or variations thereof.

The storage system 903 may comprise any computer readable storage media readable by processing system 902 and capable of storing software 905. The storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 903 may also include computer readable communication media over which at least some of the software 905 may be communicated internally or externally. The storage system 903 may be implemented as a single storage device but may also be implemented across multiple storage devices or sub-systems co-located or distributed relative to each other. The storage system 903 may comprise additional elements, such as a controller capable of communicating with the processing system 902 or possibly other systems.

The software 905 (including guidance function process 906) may be implemented in program instructions and among other functions may, when executed by the processing system 902, direct the processing system 902 to operate as described with respect to the various operational scenarios, sequences, and processes illustrated herein. For example, the software 905 may include program instructions for implementing a guidance function as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 905 may include additional processes, programs, or components, such as operating system software, virtualization software, or other application software. The software 905 may also comprise firmware or some other form of machine-readable processing instructions executable by the processing system 902.

In general, the software 905 may, when loaded into the processing system 902 and executed, transform a suitable apparatus, system, or device (of which computing system 901 is representative) overall from a general-purpose computing system into a special-purpose computing system customized to support insights features, functionality, and user experiences. Indeed, encoding the software 905 on the storage system 903 may transform the physical structure of the storage system 903. The specific transformation of the physical structure may depend on various factors in different implementations of this description. Examples of such factors may include, but are not limited to, the technology used to implement the storage media of the storage system 903 and whether the computer-storage media are characterized as primary or secondary storage, as well as other factors.

For example, if the computer readable storage media are implemented as semiconductor-based memory, the software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### Examples

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a system comprising: one or more computer readable storage media; one or more processors operatively coupled with the one or more computer readable storage media; and an application comprising program instructions stored on the one or more computer readable storage media that, when executed by the one or more processors, direct a computing system to at least: receive, from a first client device, a request to generate content within an application; initiate, by the application, a guidance function, wherein the guidance function observes interactions between the first client device and a content generator; determine, by the guidance function, a first interaction between the first client device and the content generator; determine, by the guidance function, a first text portion generated based on the first interaction between the first client device and the content generator; generate, by the guidance function, a relationship between the first text portion and the first interaction between the first client device and the content generator; and store, by the guidance function, the relationship between the first text portion and the first interaction.

Example 2 is the system of any previous or subsequent Example, wherein: the program instructions to determine, by the guidance function, the first interaction between the first client device and the content generator cause, when executed by the one or more processors, to further direct the computing system to: receive, from the first client device, a first prompt for the content generator; and receive, from the content generator, a first response generated by the content generator responsive to the first prompt; and the program instructions to generate, by the guidance function, the relationship between the first text portion and the first interaction between the first client device and the content generator cause, when executed by the one or more processors, to further direct the computing system to: generate the relationship to indicate an association between the first response generated by the content generator responsive to the first prompt and the first text portion.

Example 3 is the system of any previous or subsequent Example, wherein the program instructions to determine, by the guidance function, the first text portion generated based on the first interaction between the first client device and the content generator cause, when executed by the one or more processors, to further direct the computing system to: compare, by the guidance function, the first text portion to the first response generated by the content generator; and generate, by the guidance function, a relevancy score for the first text portion, wherein the relevancy score indicates a closeness between the first text portion and the first response generated by the content generator.

Example 4 is the system of any previous or subsequent Example, wherein the program instructions to determine, by the guidance function, the first text portion generated based on the first interaction between the first client device and the content generator cause, when executed by the one or more processors, to further direct the computing system to: determine, by the guidance function, a first time associated with the first interaction between the first client device and the content generator; determine, by the guidance function, a second time associated with generation of the first text portion within the application; compare, by the guidance function, the first time and the second time; and determine, by the guidance function, that the first text portion is related to the first interaction based on comparing the first time and the second time.

Example 5 is the system of any previous or subsequent Example, wherein the program instructions further direct the computing system to: receive a request to begin an assignment within the application; determine, by the application, one or more settings associated with the assignment; and initiate the guidance function based on the one or more settings associated with the assignment.

Example 6 is the system of any previous or subsequent Example, wherein the program instructions further direct the computing system to determine, by the guidance function, an origin format for the first text portion within the application, wherein the origin format of the first text portion within the application comprises one of the following: typed by the first client device into the application; or pasted by the first client device into the application.

Example 7 is a method comprising: receiving, from a first client device, a request to generate content within an application; initiating, by the application, a guidance function, wherein the guidance function observes interactions between the first client device and a content generator; determining, by the guidance function, a first interaction between the first client device and the content generator; determining, by the guidance function, a first text portion generated based on the first interaction between the first client device and the content generator; and generating, by the guidance function, a visual indication of a relationship between the first text portion and the first interaction between the first client device and the content generator.

Example 8 is the method of any previous or subsequent Example, wherein determining, by the guidance function, the first interaction between the first client device and the content generator further comprises: receiving, from the first client device, a first prompt for the content generator; and receiving, from the content generator, a first response generated by the content generator responsive to the first prompt.

Example 9 is the method of any previous or subsequent Example, wherein generating, by the guidance function, the visual indication of the relationship between the first text portion and the first interaction between the first client device and the content generator further comprises: generating, by the guidance function, a display comprising the first prompt and the first response generated by the content generator; and providing, by the guidance function, an indication that the first text portion is related to the first prompt and the first response generated by the content generator.

Example 10 is the method of any previous or subsequent Example, wherein providing, by the guidance function, the indication comprises highlighting, by the guidance function, the first text portion.

Example 11 is the method of any previous or subsequent Example, the method further comprising: generating, by the guidance function, an interaction history for the first client device, wherein the interaction history comprises one or more interactions between the first client device with the content generator, the one or more interactions comprising the first interaction; and providing, by the guidance function, a display of the interaction history.

Example 12 is the method of any previous or subsequent Example, wherein providing, by the guidance function, the display of the interaction history further comprising: receiving, by the guidance function, a request for the interaction history for the first client device from a second client device; and providing, by the guidance function, the display of the interaction history to the second client device.

Example 13 is the method of any previous or subsequent Example, the method further comprising: determining, by the guidance function, an origin format for the first text portion within the application, wherein the origin format of the first text portion within the application comprises one of the following: typed by the first client device into the application; or pasted by the first client device into the application.

Example 14 is the method of any previous or subsequent Example, wherein the origin format of the first text portion within the application is typed by the first client device and determining, by the guidance function, the origin format of the first text portion within the application further comprises: determining, by the guidance function, a revision score for the first text portion within the application; and determining, by the guidance function, that the first text portion within the application was generated by the content generator based on the revision score.

Example 15 is the method of any previous or subsequent Example, wherein the content generator comprises a large language model (LLM).

Example 16 is a computer readable storage media comprising processor-executable instructions configured to cause one or more processors to: receive, from a first client device, a request to generate content within an application; initiate, by the application, a guidance function, wherein the guidance function observes interactions between the first client device and a content generator; determine, by the guidance function, a first interaction between the first client device and the content generator; determine, by the guidance function, a first text portion generated based on the first interaction between the first client device and the content generator; and generate, by the guidance function, a visual indication of a relationship between the first text portion and the first interaction between the first client device and the content generator.

Example 17 is the non-transitory computer-readable medium of any previous or subsequent Example, wherein: the processor-executable instructions to determine, by the guidance function, the first interaction between the first client device and the content generator cause the processor to further execute processor-executable instructions stored in the computer readable storage media to: receive, from the first client device, a first prompt for the content generator; and receive, from the content generator, a first response generated by the content generator responsive to the first prompt; and the processor-executable instructions to generate, by the guidance function, the visual indication of a relationship between the first text portion and the first interaction between the first client device and the content generator cause the processor to further execute processor-executable instructions stored in the computer readable storage media to: provide, by the guidance function, a first display comprising the first prompt and the first response generated by the content generator responsive to the first prompt; and provide, by the guidance function, an indication that the first text portion is related to the first display.

Example 18 is the computer readable storage media of any previous or subsequent Example, wherein the processor-executable instructions cause the processor to further execute processor-executable instructions stored in the computer readable storage media to: determine, by the guidance function, a second interaction between the first client device and the content generator; determine, by the guidance function, a second text portion generated based on the second interaction between the first client device and the content generator; and generate, by the guidance function, a visual indication of a relationship between the first text portion and the first interaction between the first client device and the content generator.

Example 19 is the computer readable storage media of any previous or subsequent Example, wherein the processor-executable instructions cause the processor to further execute processor-executable instructions stored in the computer readable storage media to: generate, by the guidance function, an interaction history for the first client device, wherein the interaction history comprises one or more interactions between the first client device with the content generator, the one or more interactions comprising the first interaction; and provide, by the guidance function, a display of the interaction history.

Example 20 is the computer readable storage media of any previous or subsequent Example, wherein the processor-executable instructions to generate, by the guidance function, the interaction history cause the processor to further execute processor-executable instructions stored in the computer readable storage media to: generate, by the guidance function, the interaction history for a second client device, wherein the interaction history comprises one or more interactions between the second client device with the content generator; and provide, by the guidance function, the display of the interaction history to a third client device.

What is claimed is:

1. A system comprising:
one or more computer readable storage media;
one or more processors operatively coupled with the one or more computer readable storage media; and
an application comprising program instructions stored on the one or more computer readable storage media that, when executed by the one or more processors, direct a computing system to at least:
receive, from a first client device, a request to generate content within an application;
initiate, by the application, a guidance function, wherein the guidance function observes interactions between the first client device and a content generator;
determine, by the guidance function, a first interaction between the first client device and the content generator;
determine, by the guidance function, a first text portion generated based on the first interaction between the first client device and the content generator;
generate, by the guidance function, a relationship between the first text portion and the first interaction between the first client device and the content generator; and
store, by the guidance function, the relationship between the first text portion and the first interaction.

2. The system of claim 1, wherein:
the program instructions to determine, by the guidance function, the first interaction between the first client device and the content generator cause, when executed by the one or more processors, to further direct the computing system to:
receive, from the first client device, a first prompt for the content generator; and
receive, from the content generator, a first response generated by the content generator responsive to the first prompt; and
the program instructions to generate, by the guidance function, the relationship between the first text portion and the first interaction between the first client device and the content generator cause, when executed by the one or more processors, to further direct the computing system to:
generate the relationship to indicate an association between the first response generated by the content generator responsive to the first prompt and the first text portion.

3. The system of claim 2, wherein the program instructions to determine, by the guidance function, the first text portion generated based on the first interaction between the first client device and the content generator cause, when executed by the one or more processors, to further direct the computing system to:
compare, by the guidance function, the first text portion to the first response generated by the content generator; and
generate, by the guidance function, a relevancy score for the first text portion, wherein the relevancy score indicates a closeness between the first text portion and the first response generated by the content generator.

4. The system of claim 1, wherein the program instructions to determine, by the guidance function, the first text portion generated based on the first interaction between the first client device and the content generator cause, when executed by the one or more processors, to further direct the computing system to:
determine, by the guidance function, a first time associated with the first interaction between the first client device and the content generator;
determine, by the guidance function, a second time associated with generation of the first text portion within the application;
compare, by the guidance function, the first time and the second time; and
determine, by the guidance function, that the first text portion is related to the first interaction based on comparing the first time and the second time.

5. The system of claim 1, wherein the program instructions further direct the computing system to:
receive a request to begin an assignment within the application;
determine, by the application, one or more settings associated with the assignment; and
initiate the guidance function based on the one or more settings associated with the assignment.

6. The system of claim 1, wherein the program instructions further direct the computing system to determine, by the guidance function, an origin format for the first text portion within the application, wherein the origin format of the first text portion within the application comprises one of the following:
typed by the first client device into the application; or
pasted by the first client device into the application.

7. A method comprising:
receiving, from a first client device, a request to generate content within an application;
initiating, by the application, a guidance function, wherein the guidance function observes interactions between the first client device and a content generator;
determining, by the guidance function, a first interaction between the first client device and the content generator;
determining, by the guidance function, a first text portion generated based on the first interaction between the first client device and the content generator; and
generating, by the guidance function, a visual indication of a relationship between the first text portion and the first interaction between the first client device and the content generator.

8. The method of claim 7, wherein determining, by the guidance function, the first interaction between the first client device and the content generator further comprises:
receiving, from the first client device, a first prompt for the content generator; and
receiving, from the content generator, a first response generated by the content generator responsive to the first prompt.

9. The method of claim 8, wherein generating, by the guidance function, the visual indication of the relationship between the first text portion and the first interaction between the first client device and the content generator further comprises:
generating, by the guidance function, a display comprising the first prompt and the first response generated by the content generator; and
providing, by the guidance function, an indication that the first text portion is related to the first prompt and the first response generated by the content generator.

10. The method of claim 9, wherein providing, by the guidance function, the indication comprises highlighting, by the guidance function, the first text portion.

11. The method of claim 7, the method further comprising:
generating, by the guidance function, an interaction history for the first client device, wherein the interaction history comprises one or more interactions between the first client device with the content generator, the one or more interactions comprising the first interaction; and
providing, by the guidance function, a display of the interaction history.

12. The method of claim 11, wherein providing, by the guidance function, the display of the interaction history further comprising:
receiving, by the guidance function, a request for the interaction history for the first client device from a second client device; and
providing, by the guidance function, the display of the interaction history to the second client device.

13. The method of claim 7, the method further comprising:
determining, by the guidance function, an origin format for the first text portion within the application, wherein the origin format of the first text portion within the application comprises one of the following:
typed by the first client device into the application; or
pasted by the first client device into the application.

14. The method of claim 13, wherein the origin format of the first text portion within the application is typed by the first client device and determining, by the guidance function, the origin format of the first text portion within the application further comprises:
determining, by the guidance function, a revision score for the first text portion within the application; and
determining, by the guidance function, that the first text portion within the application was generated by the content generator based on the revision score.

15. The method of claim 7, wherein the content generator comprises a large language model (LLM).

16. A computer readable storage media comprising processor-executable instructions configured to cause one or more processors to:
receive, from a first client device, a request to generate content within an application;
initiate, by the application, a guidance function, wherein the guidance function observes interactions between the first client device and a content generator;
determine, by the guidance function, a first interaction between the first client device and the content generator;
determine, by the guidance function, a first text portion generated based on the first interaction between the first client device and the content generator; and
generate, by the guidance function, a visual indication of a relationship between the first text portion and the first interaction between the first client device and the content generator.

17. The non-transitory computer-readable medium of claim 16, wherein:
the processor-executable instructions to determine, by the guidance function, the first interaction between the first client device and the content generator cause the processor to further execute processor-executable instructions stored in the computer readable storage media to:
receive, from the first client device, a first prompt for the content generator; and
receive, from the content generator, a first response generated by the content generator responsive to the first prompt; and
the processor-executable instructions to generate, by the guidance function, the visual indication of a relationship between the first text portion and the first interaction between the first client device and the content generator cause the processor to further execute processor-executable instructions stored in the computer readable storage media to:
provide, by the guidance function, a first display comprising the first prompt and the first response generated by the content generator responsive to the first prompt; and
provide, by the guidance function, an indication that the first text portion is related to the first display.

18. The computer readable storage media of claim 16, wherein the processor-executable instructions cause the processor to further execute processor-executable instructions stored in the computer readable storage media to:
determine, by the guidance function, a second interaction between the first client device and the content generator;
determine, by the guidance function, a second text portion generated based on the second interaction between the first client device and the content generator; and
generate, by the guidance function, a visual indication of a relationship between the first text portion and the first interaction between the first client device and the content generator.

19. The computer readable storage media of claim 16, wherein the processor-executable instructions cause the processor to further execute processor-executable instructions stored in the computer readable storage media to:
generate, by the guidance function, an interaction history for the first client device, wherein the interaction history comprises one or more interactions between the first client device with the content generator, the one or more interactions comprising the first interaction; and
provide, by the guidance function, a display of the interaction history.

20. The computer readable storage media of claim 19, wherein the processor-executable instructions to generate, by the guidance function, the interaction history cause the processor to further execute processor-executable instructions stored in the computer readable storage media to:
generate, by the guidance function, the interaction history for a second client device, wherein the interaction history comprises one or more interactions between the second client device with the content generator; and
provide, by the guidance function, the display of the interaction history to a third client device.
